(19) United States
(12) Patent Application Publication
(10) Pub. No.: US 2019/0090452 A1
(43) Pub. Date: Mar. 28, 2019

(54) PET WAITER SYSTEM AND METHOD THEREFOR

(71) Applicant: ENEDINA GRIJALVA, LAVEEN, AZ (US)

(72) Inventor: ENEDINA GRIJALVA, LAVEEN, AZ (US)

(21) Appl. No.: 15/715,633

(22) Filed: Sep. 26, 2017

(51) Int. Cl. A01K 5/01; A01K 5/02; A01K 7/02

(52) U.S. Cl. CPC A01K 5/0142; A01K 7/025; A01K 5/0225

(57) ABSTRACT

A pet waiter system is an innovative and useful device for easily and efficiently feeding domesticated pets, such as cats and dogs. The system may include a pet nourishment station assembly, a container holding member, a tray elevator assembly, and a mechanical lift mechanism. In use, a nourishment tray may be easily adjusted vertically by rotating a handle to raise and lower the nourishment tray for making it easier on a user to dispense a ration of pet-food and drinking-water which may serve to reduce injury caused from excessive bending.

### RELATED APPLICATIONS

The present application is related to U.S. Pat. No. 8,776,725 entitled, “PET WAITER SYSTEMS”, filed Mar. 29, 2013, in the name of the same inventor, and which is incorporated herewith.

### TECHNICAL FIELD

The present invention relates generally to the field of pet food serving devices, and more specifically, to pet waiter systems comprising a mechanical multifunctional pet feeding system.

### BACKGROUND

Many individuals have pets. The task of feeding one's pet when at work or away from home may present problems. Many pet owners are familiar with the fact that a pet's food may attract ants or other crawling insects. Especially during warm weather, food left in an open container may become infested with bugs within a matter of hours and consumption may be unhealthy and distasteful for a pet. Quite often pets may just choose to go hungry, ignoring the infested food bowl altogether. As a result, the owner must discard and replace entire bowls of food which, over time, may prove to be very costly.

In addition, dogs and cats may become discouraged, not to mention hungry, when their owner is working late because of a business meeting or is tied up for hours in traffic. While keeping their pets sufficiently fed is a daily concern of pet owners, the challenge is exacerbated if they are planning on going on vacation. To ensure proper care for their companions, dog and cat owners will usually commission a friend or neighbor to feed their animals while they are away. Although these substitute caregivers have the best intentions, their own busy lives could hinder them from feeding the animal every time it is needed. Worried over such a scenario, pet owners may find themselves too concerned about the care of their pet to enjoy a relaxing time away from home. Lastly, even when the owner is present to monitor possible insect infestation and to feed the pet on time, the nourishment regimen may prove physically taxing on the person. Constantly bending over to fill bowls or to pick them up for cleaning may wreak havoc on bad backs, stiff joints, and arthritic muscles.

Various attempts have been made to solve the above-mentioned problems such as those found in U.S. Pat. No. 5,433,171 to Anthony S. Ewell; U.S. Pat. No. 6,135,056 to Yung-Fang Kuo; U.S. Pat. No. 6,988,465 to Sung Ho Park; U.S. Pat. No. 8,245,665 to Shelley Sue Willett; and U.S. Pat. No. 7,469,657 to Alec Drummond. These prior art references are representative of automated pet food and water dispensers. None of the above inventions and patents, taken either singly or in combination, is seen to describe the invention as claimed.

U.S. Pat. No. 8,776,725 to Enedina Grijalva discloses a pet nutrition system. The pet nutrition system has a nourishment tray which may be easily adjusted vertically via a handy control panel for making it easier on a user to dispense a ration of pet-food and drinking-water into the bowls contained within the nourishment tray. The pet nutrition system uses a motor assembly to raise and lower the nourishment tray which may serve to reduce injury caused from excessive bending. However, the control panel and motor assembly increase the complexity and cost of the system. Further, the motor assembly increases the weight of the system making the system difficult to move and thus, not easily portable.

Ideally, pet waiter systems should provide an easy-to-use pet nourishment system and, yet would operate reliably and be manufactured at a modest expense. Thus, a need exists for pet waiter systems, a multifunctional pet-food and drinking-water dispensing device to avoid the above-mentioned problems.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a pet waiter system is disclosed. The pet waiter system comprising: a pet nourishment station assembly comprising: a station stand; a vertical column; and a vertical column mount; a container holding member comprising; a food container holder, and a water container holder, a tray elevator assembly comprising: a nourishment tray; a connector attached to the nourishment tray; a vertical track; and a mechanical lift mechanism comprising; a spool assembly; a cable attached to said spool assembly; a bushing attached to said connector and said cable; wherein said station stand comprises a food-section, a mid-section, and a water-section; wherein said vertical column comprises a shaft having a bottom end and a top end; wherein said bottom end of said vertical column is mounted to a top surface of said mid-section of said station stand via said vertical column mount; wherein said container holding member is fixedly mounted to a front portion near said top end of said vertical column; wherein said food container holder is located at a first-end of said container holding member and retains a food container such that said food container is suspended above said food-section of said station stand; wherein said water container holder is located at a second-end of said container holding member and retains a water container such that said water container is suspended above said water-section of said station stand; wherein said vertical track of said tray elevator assembly runs vertically from said bottom end to said top end within said shaft of said vertical column; wherein said tray platform comprises a planar surface and is connected to said vertical track; wherein said tray platform holds said nourishment tray; wherein said mechanical lift mechanism is connected to said container holding member; wherein said nourishment tray comprises a food bowl receptacle and a water bowl receptacle for receiving a food bowl and a water bowl respectively; wherein rotation of said spool assembly in a first direction causes said cable to rotate said bushing raising said nourishment tray and rotation of said spool assembly in a second direction causes said cable to rotate said bushing lowing said nourishment tray; wherein said pet nourishment station assembly, said tray elevator assembly, and said motor assembly work in combination to form said pet waiter systems; and wherein said pet waiter systems serves to efficiently dispense a ration of food and water for feeding and nourishing a pet while conserving physical energy and excessive bending.

In accordance with another aspect of the present application, a pet waiter system comprising: a pet nourishment station assembly comprising: a station stand; a vertical column mount formed within said station stand; a vertical column having tracks formed therein, said tracks running vertically from a bottom end of said vertical column to a top end of said vertical column, a bottom end of said vertical column positioned within said vertical column mount; a container holding member fixedly mounted to a front portion near a top end of said vertical column comprising; a food container holder retaining a food container above said station stand; and a water container holder retaining a water container above said water-section of said station stand; a tray elevator assembly comprising: a nourishment tray; and a connector attached to the nourishment tray and having rails engaging said tracks; and a mechanical lift mechanism connected to said container holding member comprising; a spool assembly; a cable attached to said spool assembly; and a bushing attached to said connector and said cable, wherein rotation of said spool assembly in a first direction causes said cable to rotate said bushing raising said nourishment tray and rotation of said spool assembly in a second direction causes said cable to rotate said bushing lowing said nourishment tray.

### BRIEF DESCRIPTION OF DRAWINGS

Embodiments of the disclosure will become more fully understood from the detailed description and the accompanying drawings, wherein:

FIG. 1 is a perspective view of a pet waiter system in accordance with one aspect of the present application;

FIG. 2 is a front view of the pet waiter system in accordance with one aspect of the present application;

FIG. 3 is a side view of the pet waiter system in accordance with one aspect of the present application;

FIG. 4A-4B are magnified view of the storage container holding unit of the pet waiter system in accordance with one aspect of the present application;

FIG. 5A-5B are magnified view of the lifting tray of the pet waiter system in accordance with one aspect of the present application

FIG. 6 is an exploded magnified view of the lifting unit of the pet waiter system in accordance with one aspect of the present application; and

FIG. 7A-7C show front views of the pet waiter system with a lifting tray at different heights in accordance with one aspect of the present application.

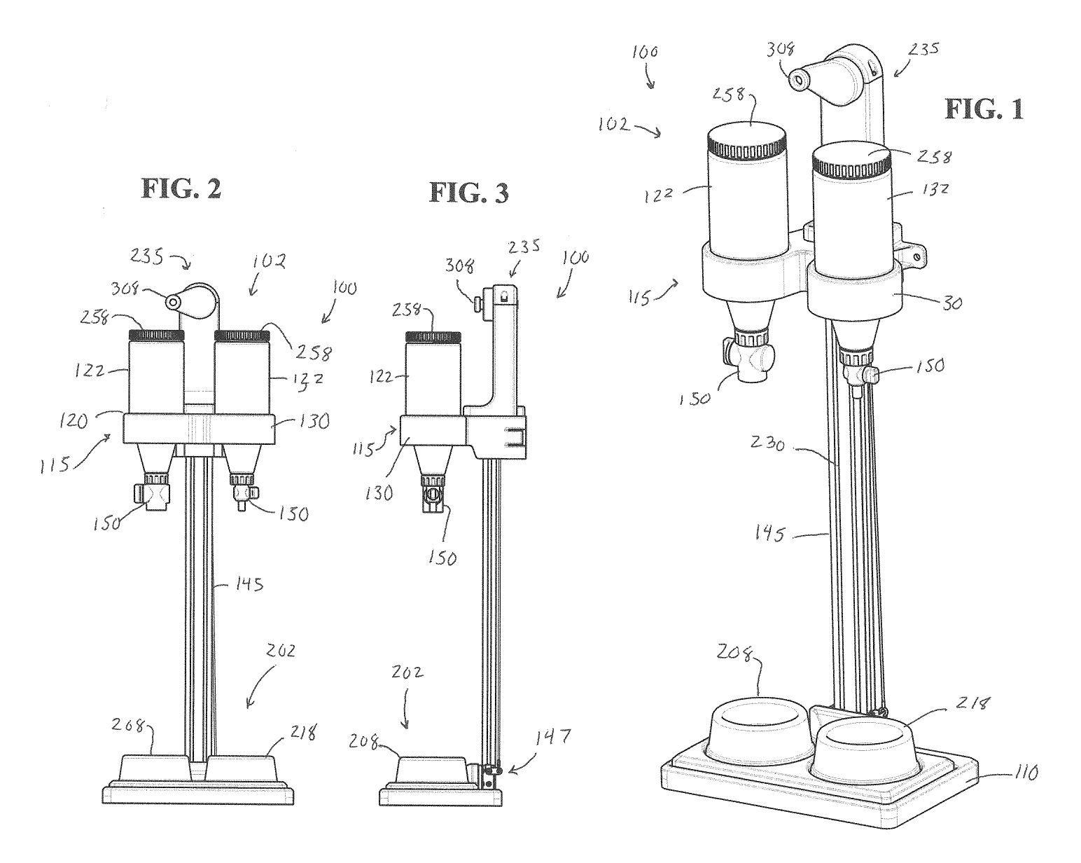

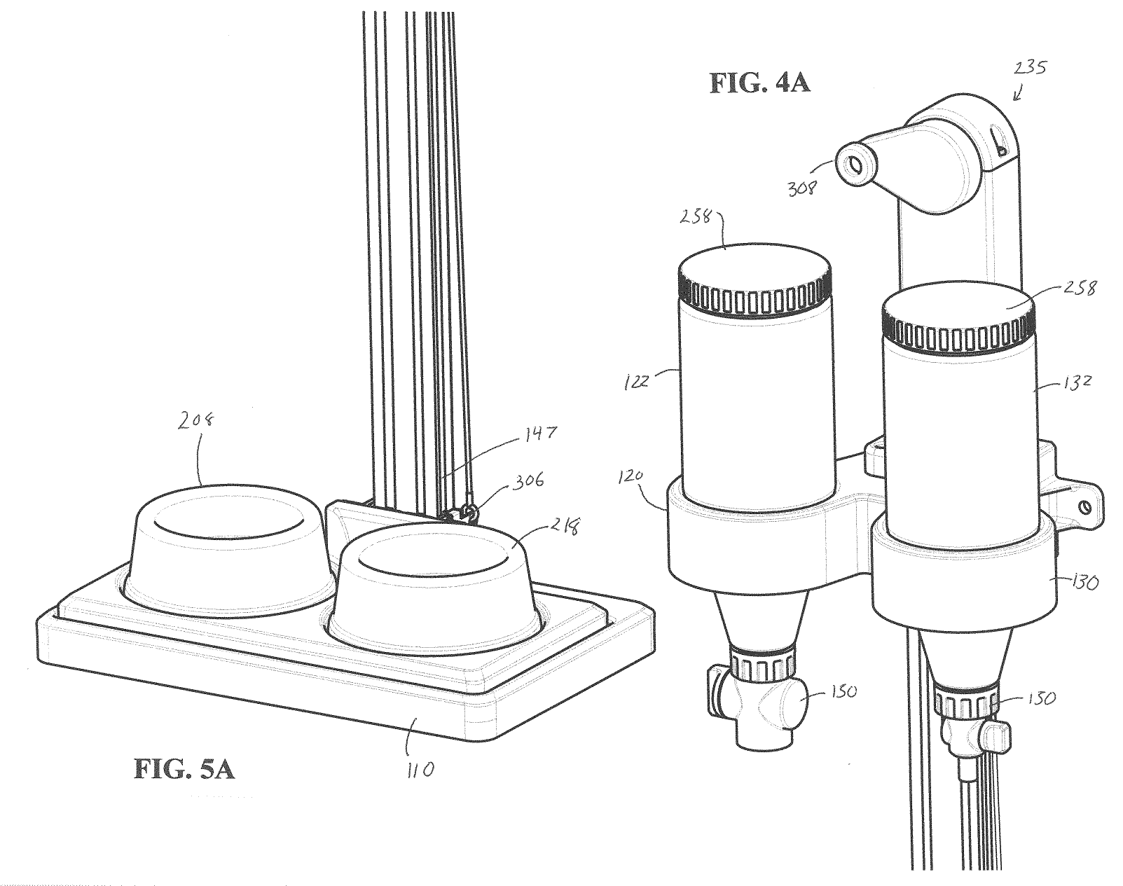

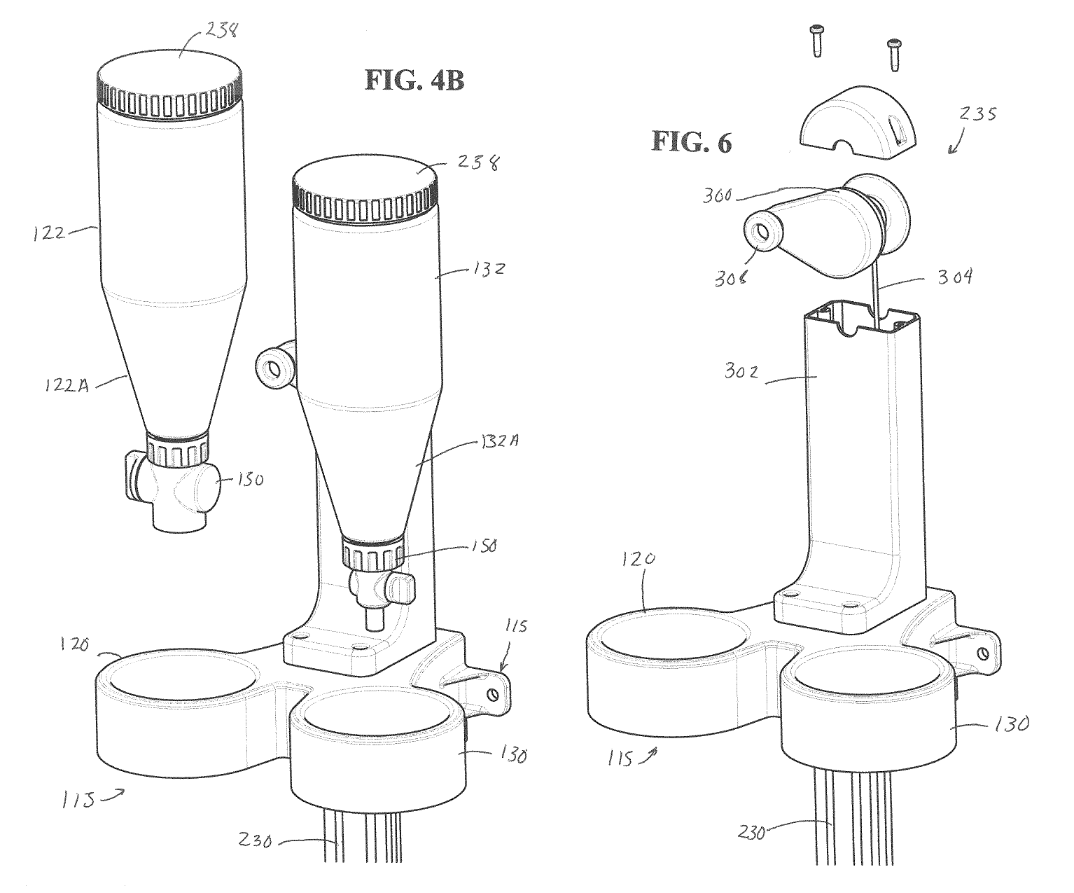

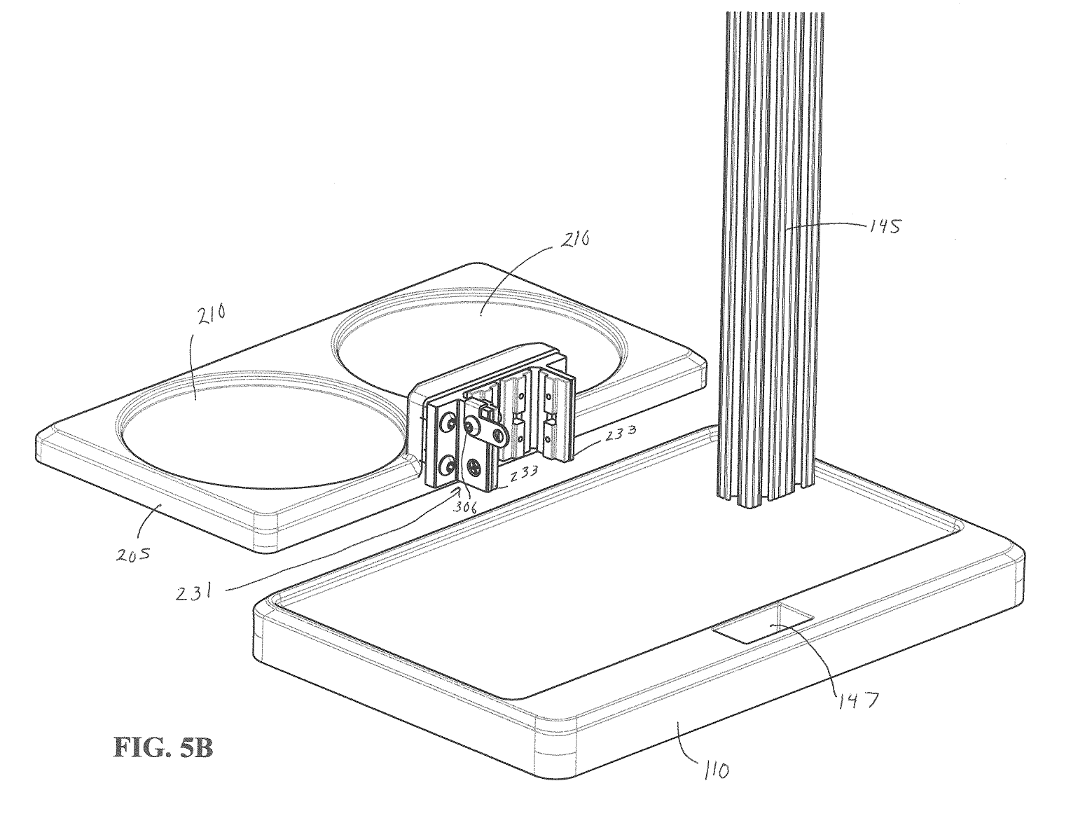

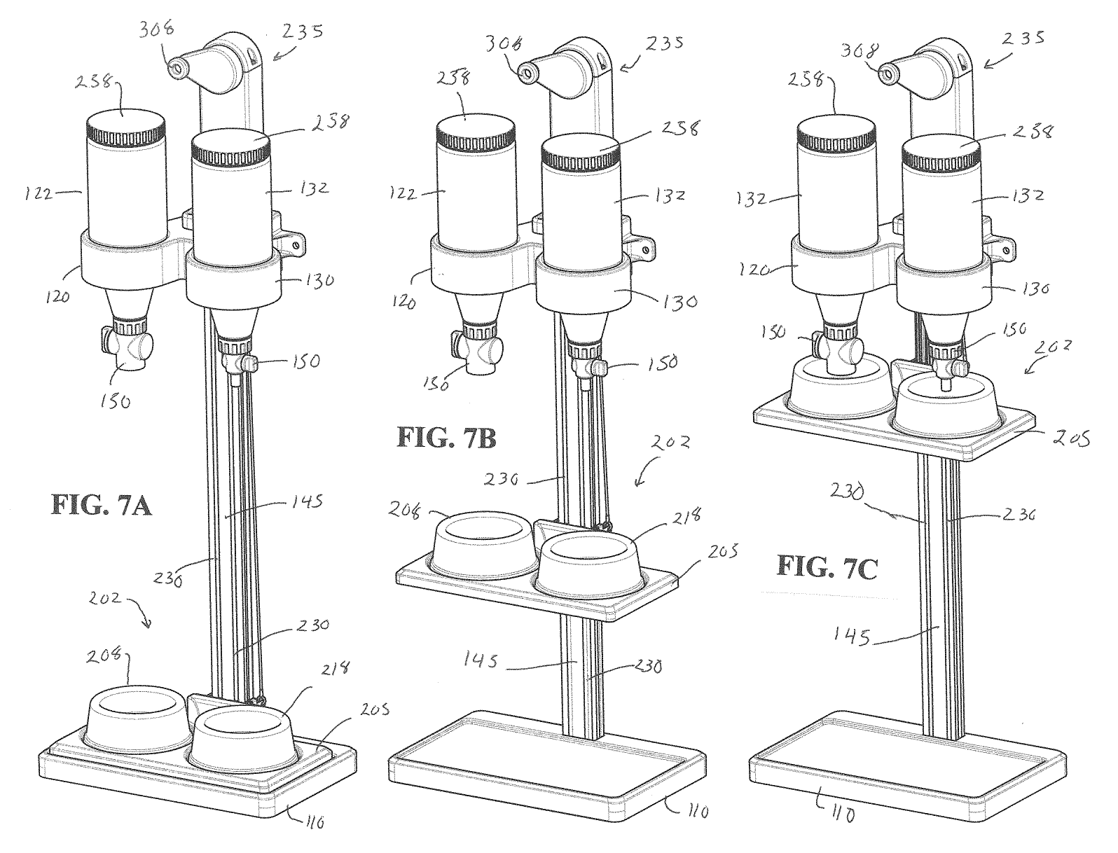

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

As discussed above, embodiments of the present invention relate to a pet feeding device and more particularly to a pet waiter as used to improve the efficiency of feeding and nourishing pets.

Generally speaking, the pet waiter system may comprise a multifunctional pet nourishment station that elevates the pet's bowls while also providing a feeding and watering system. The pet waiter system may feature dimensions of approximately three feet (3′) in height, nine inches (9″) in width, and three inches (3″) in depth. The pet waiter system may be fashioned from a titanium or steel material for optimal durability. The bottom of the pet waiter system may offer a rectangular tray system, which may house the food and water bowls for a pet. The provided rectangular tray system may be expandable to increase in size as a puppy or kitten grows into an adult dog or cat. The present invention may be used indoors or outdoors. Dish covers may also be provided with the system to protect food and water when the pet is not enjoying them.

The rectangular tray system is integrally attached to a vertical column, which serves as a conveyance for raising and lowering the rectangular tray system as needed. A mechanical pulley system may be used to raise and lower the rectangular tray system to a desired height. A feeding and watering system of the pet waiter system may comprise two (2) food and water canisters that may be generally cylindrical in shape. The food and water canisters may be secured at the top of the feeding and watering system and capped with a lid equipped with a durable rubber seal to maintain freshness, each of these canisters sufficiently stores a user-determined amount of food and water. Positioned inside the canisters, a manually operated lever may be provided for manually dispensing the food and water. In an alternative embodiment, each canister may comprise a time-operated release door which may serve to distribute food and water down an open, tapered chute, which leads straight into the provided feeding and watering bowl.

The pet waiter system may afford pets, and pet owners, many significant benefits and advantages. First, this invention effectively prevents the infestation of pet food by ants and other crawling insects. Handily elevating the bowls from the accessibility of the floor, the pet waiter system may prevent an animal from getting sick from consuming food which has been infested, saving owners the cost of incurring subsequent veterinary bills.

In addition, the unique design of pet waiter system eliminates the need to continually change out food which has attracted ants and other bugs, thereby maximizing the life of a pet's food and adding up to a large savings in reduced purchases. The added bowl lids also keep insects away, while also preventing dust and dirt from entering the pet dishes. Another important advantage of the pet waiter system is that it provides pet owners with an easy and convenient means of keeping their animals fed and hydrated while away from home. Incorporating a manual food and water dispenser system, this handy product supplies dogs and cats with their daily meals at the times they are used to eating. Whether a dog owner will only be out for one evening or a cat owner will be out for several days, pet waiter systems intricately designed controls provide fresh food and water for pets for the entire duration. The manual food and water dispenser system lessens the weight and cost of the pet waiter system allowing the pet waiter system to be affordable and portable.

Referring now to the FIGs., a pet waiter system 100 according to an embodiment of the present invention may be seen. The pet waiter system 100 may comprise a pet nourishment station assembly 102. The pet nourishment station assembly 102 may generally comprise a station stand 110, vertical column 145, and vertical column mount 147. The station stand 110 of the pet nourishment station assembly 102 may comprise a food-section, a mid-section, and a water-section. Vertical column 145 may comprise a shaft having a bottom-end and a top-end. As shown, the bottom-end of vertical column 145 is mounted to a top surface of the mid-section of station stand 110 via vertical column mount 147.

The pet waiter system 100 may further comprise a container holding member 115 which may include a food container holder 120 and a water container holder 130. The food container holder 120 may be located at a first-end of container holding member 115 and retains a food container 122 such that the food container 122 may be suspended above the food-section of the station stand 110. The water container holder 130 may be located at a second-end of the container holding member 115 and retains a water container 132 such that water container 132 may be suspended above the water-section of the station stand 110. The food container holder 120 of the container holding member 115 may be useful for retaining the food container 122 which may contain pet-food. The pet-food may then be selectively dispensed to pet by a user. The water container holder 130 of the container holding member 115 may be useful for retaining the water container 132 for holding drinking-water which also may be selectively dispensed to the pet by the user. It should be appreciated that pet nourishment station assembly 102 and container holding member 115 may be formed of durable plastic material for long lasting use.

In accordance with one embodiment, the food container holder 120 and the water container holder 130 may be ring members. The ring members may have a circumference approximate in size to a circumference of the food container 122 and/or the water container holder 130. A slide resistant material 116 may be formed around an interior of the food container holder 120 and the water container holder 130. The slide resistant material 116 may be used to firmly secure the food container 122 and the water container 132 within the food container holder 120 and the water container holder 130 respectively.

In accordance with one embodiment, the food container 122 and the water container 132 may be generally comprise canisters that are cylindrical in shape. The food container 122 and the water container 132 may be manufactured out of light-weight, durable material such as plastic or the like. In accordance with one embodiment, the food container 122 and the water container 132 may be formed of a transparent plastic material to allow one to see the level of the contents stored within the food container 122 and the water container 132.

The food and water containers 122 and 132 respectively, may have a tapering funnel end 122A and 132A respectively. The tapering funnel end 122A and 132A may help to dispense the contents stored within the food and water containers 122 and 132 respectively.

A manually operated dispensing mechanism 150 may be provided for manually dispensing the contents stored within the food and water containers 122 and 132 respectively. In an alternative embodiment, a time-operated release door may serve to distribute the contents stored within the food and water containers 122 and 132 respectively.

The food and water containers 122 and 132 respectively may each have a lid 258 on a top area thereof. The lid 258 may be equipped with a durable rubber seal to maintain an air tight seal. The air tight seal may provide for freshness of the contents stored in the food and water containers 122 and 132 respectively. The air tight seal may further prevent bugs, insects, bacteria and other contaminants from getting into the food and water containers 122 and 132 respectively thereby reducing sickness to the pet using the pet waiter system 100.

In accordance with one embodiment, the pet waiter system 100 in a ‘non-use’ condition may have a food bowl lid (not shown) and a water bowl lid (not shown) covering the food bowl 208 and the water bowl 218 respectively. The food bowl lid and the water bowl lid may prevent the infestation of the pet food/water by ants, flies, mosquitoes, and other insects.

The pet waiter system 100 may further comprise a tray elevator assembly 202. The tray elevator assembly 202 may comprise a nourishment tray 205 a vertical track 230, and a mechanical lift mechanism 235. The mechanical lift mechanism 235 may be used to manually raise and lower the tray elevator assembly 202. By raising and lowering the tray elevator assembly 202, the user may easily and conveniently feed at least one pet without having to excessively bend down at the waist, thus serving to prevent unnecessary injury.

The vertical track 230 of the tray elevator assembly 202 may run vertically from the bottom end to the top-end of the shaft within the vertical column 145. The nourishment tray 205 of the tray elevator assembly 202 may comprise a planar surface and may be connected to the vertical track 230 via a connector 231. The mechanical lift mechanism 235 of the tray elevator assembly 202 may be connected to the nourishment tray 205 within the vertical column 145 in order to raise and lower the tray platform 225.

In accordance with one embodiment, the connector 231 has a pair of guide rails 233. The guide rails 233 may be positioned within the vertical tracks 230 formed within the within the vertical column 145. The guide rails 233 and the corresponding vertical tracks 230 may allow the nourishment tray 205 to stay level while moving up and down along the vertical column 145.

The nourishment tray 205 may have indentations 210 formed therein. The indentations 210 may be used to secure the food bowl 208 and/or water bowl 218 on the nourishment tray 205. In accordance with one embodiment, the indentations 210 may be of the same shape and size of a bottom area of the food bowl 208 and/or water bowl 218. The food bowl 208 and/or water bowl 218 may be inserted into a respective indentation 210 thereby preventing the food bowl 208 and/or water bowl 218 from moving/tipping over. In accordance with one embodiment, inserts may be provided to adjust a size of the indentations. This may allow one to place different size food bowls 208 and/or water bowls 218 in the indentations based on the size of the pet.

The mechanical lift mechanism 235 may be coupled to the connector 231 in order to raise and lower the tray platform 225. In accordance with one embodiment, the mechanical lift mechanism 235 comprises a spool assembly 300. The spool assembly 300 may be positioned within a housing 302. The housing 302 may be placed on a top surface of the container holding member 115. The spool assembly 300 may be coupled to the housing 302 such that the spool assembly 300 may be rotatable within the housing 302.

A cable 304 may be attached to the spool assembly 300. The cable 304 may further be attached to a bushing 306 which is attached to the connector 231. By rotating the spool assembly 300, the cable 304 in turn rotates the bushing 306, which may allow one to raise and lower the tray platform 225. In accordance with one embodiment, a handle 308 may be attached to the spool assembly 300 to allow the user to more easily rotate the spool assembly 300.

Thus, as may be seen in FIGS. 8A-8C, when a user rotates the handle 308 in a first direction (for example clockwise), the cable 304 draws the tray platform 225 upwards. The user may continue to rotate the handle 304 in this first direction till the tray platform 225 is directly underneath the food and water containers 122 and 132. The user may dispense the contents in the food and water containers 122 and 132 into the food bowl 208 and the water bowl 218 by using the dispensing mechanism 150. The user may then rotate the handle 308 in a second direction (for example counter-clockwise), the cable 304 lowering the tray platform 225 downwards to ground level.

While embodiments of the disclosure have been described in terms of various specific embodiments, those skilled in the art will recognize that the embodiments of the disclosure may be practiced with modifications within the spirit and scope of the claims.

What is claimed is:

1. A pet waiter system comprising:
a pet nourishment station assembly comprising:
a station stand;
a vertical column; and
a vertical column mount;
a container holding member comprising;
a food container holder; and
a water container holder;
a tray elevator assembly comprising:
a nourishment tray;
a connector attached to the nourishment tray;
a vertical track; and
a mechanical lift mechanism comprising;
a spool assembly;
a cable attached to said spool assembly;
a bushing attached to said connector and said cable;
wherein said station stand comprises a food-section, a mid-section, and a water-section;
wherein said vertical column comprises a shaft having a bottom end and a top end;
wherein said bottom end of said vertical column is mounted to a top surface of said mid-section of said station stand via said vertical column mount;
wherein said container holding member is fixedly mounted to a front portion near said top end of said vertical column;
wherein said food container holder is located at a first-end of said container holding member and retains a food container such that said food container is suspended above said food-section of said station stand;
wherein said water container holder is located at a second-end of said container holding member and retains a water container such that said water container is suspended above said water-section of said station stand;
wherein said vertical track of said tray elevator assembly runs vertically from said bottom end to said top end within said shaft of said vertical column;
wherein said tray platform comprises a planar surface and is connected to said vertical track;
wherein said tray platform holds said nourishment tray;
wherein said mechanical lift mechanism is connected to said container holding member;
wherein said nourishment tray comprises a food bowl receptacle and a water bowl receptacle for receiving a food bowl and a water bowl respectively;
wherein rotation of said spool assembly in a first direction causes said cable to rotate said bushing raising said nourishment tray and rotation of said spool assembly in a second direction causes said cable to rotate said bushing lowing said nourishment tray;
wherein said pet nourishment station assembly, said tray elevator assembly, and said motor assembly work in combination to form said pet waiter systems; and
wherein said pet waiter systems serves to efficiently dispense a ration of food and water for feeding and nourishing a pet while conserving physical energy and excessive bending.

2. The pet waiter system of claim 1 further comprising a housing coupled to said container holding member, said spool assembly rotatable within said housing.

3. The pet waiter system of claim 1 further comprising a handle coupled to said spool assembly.

4. The pet waiter system of claim 1 further comprising indentations formed within said nourishment tray, said indentations sized to prevent movement of bowls positioned within said indentations.

5. The pet waiter system of claim 1 further comprising:
a first indentation formed within said nourishment tray, said first indentation sized to prevent movement of a food bowl positioned within said first indentation; and
a second indentation formed within said nourishment tray, said second indentation sized to prevent movement of a water bowl positioned within said second indentation.

6. The pet waiter system of claim 1 wherein said food container comprises a food canister that is cylindrical in shape, wherein said food canister has a tapering funnel end.

7. The pet waiter system of claim 6 wherein said food container comprises an air tight food lid.

8. The pet waiter system of claim 6 wherein said food container comprises a first manually-operated lever attached to said tapering funnel end of said food canister.

9. The pet waiter system of claim 1 wherein said water container comprises a water canister that is cylindrical in shape, wherein said water canister has a tapering funnel end.

10. The pet waiter system of claim 9 wherein said water container comprises an air tight water lid.

11. The pet waiter system of claim 9 wherein said water container comprises a second manually-operated lever attached to said tapering funnel end of said water canister.

12. A pet waiter system comprising:
a pet nourishment station assembly comprising:
a station stand;
a vertical column mount formed within said station stand;
a vertical column having tracks formed therein, said tracks running vertically from a bottom end of said vertical column to a top end of said vertical column, a bottom end of said vertical column positioned within said vertical column mount;
a container holding member fixedly mounted to a front portion near a top end of said vertical column comprising;
a food container holder retaining a food container above said station stand; and
a water container holder retaining a water container above said water-section of said station stand;
a tray elevator assembly comprising:
a nourishment tray; and
a connector attached to the nourishment tray and having rails engaging said tracks; and
a mechanical lift mechanism connected to said container holding member comprising;
a spool assembly;
a cable attached to said spool assembly; and
a bushing attached to said connector and said cable, wherein rotation of said spool assembly in a first direction causes said cable to rotate said bushing raising said nourishment tray and rotation of said spool assembly in a second direction causes said cable to rotate said bushing lowing said nourishment tray.

13. The pet waiter system of claim 12 further comprising a housing coupled to said container holding member, said spool assembly rotatable within said housing.

14. The pet waiter system of claim 12 further comprising a handle coupled to said spool assembly.

15. The pet waiter system of claim 12 further comprising indentations formed within said nourishment tray, said indentations sized to prevent movement of bowls positioned within said indentations.

16. The pet waiter system of claim 12 wherein said food container comprises:
a food canister that is cylindrical in shape, wherein said food canister has a tapering funnel end;
an air tight food lid removable from said food canister; and
a first manually-operated lever attached to said tapering funnel end of said food canister.

17. The pet waiter system of claim 12 wherein said water container comprises:
a water canister that is cylindrical in shape, wherein said water canister has a tapering funnel end.
an air tight water lid removable from said water canister; and
a second manually-operated lever attached to said tapering funnel end of said water canister.
